(19) United States
(12) Patent Application Publication
(10) Pub. No.: US 2024/0400149 A1
(43) Pub. Date: Dec. 5, 2024

(54) DISPLAY HOUSING FOR A VEHICLE

(71) Applicant: Indian Motorcycle International, LLC, Medina, MN (US)

(72) Inventors: Joshua J. Vorderbruggen, Clearbrook, MN (US); William C. Peters, II, Rice, MN (US)

(73) Assignee: Indian Motorcycle International, LLC, Medina, MN (US)

(21) Appl. No.: 18/696,224

(22) PCT Filed: Sep. 27, 2022
(86) PCT No.: PCT/US2022/077075

§ 371 Date: Mar. 27, 2024

Related U.S. Application Data
(60) Provisional application No. 63/249,767, filed on Sep. 29, 2021.

(51) Int. Cl. B62J 50/21; B62K 21/12

(52) U.S. Cl. CPC B62J 50/225; B62K 21/12

(57) ABSTRACT

The enclosed disclosure relates to the use of handlebar risers on vehicles that have handlebar assemblies. The embodiments described within provide an improvement in the way a display is mounted on a vehicle with a handlebar riser. In the described embodiment enclosed, a display mount is integral to the structure of a handlebar riser, configured to provide rigidity to the subsystem in addition to raising the height of the display closer to the operator. More specifically a vehicle with a plurality of ground engaging members and a steering system configured to steer the vehicle, wherein the steering system comprises a plurality of generally vertical tubes, a steering arm and a support structure having a first portion extending between the generally vertical tubes and a second portion configured to support a display device.

### FIELD OF THE DISCLOSURE

The present disclosure relates to vehicle display mounts, and specifically the use of display mounts as supporting structure in a steering assembly.

### BACKGROUND OF THE DISCLOSURE

Vehicles with handlebar assemblies are well known in the art. Handlebars are often used as steering assemblies but may be further used as a grasping assembly for an operator or passenger. Handlebar risers are subassemblies used to increase the vertical height and, in some cases, longitudinal position of the handlebars relative to the operator or passenger. Vehicle displays are common and integrating those with handlebar assemblies with handlebar risers has inherent challenges. Previous designs have mounted displays below the risers or longitudinally displaced from the handlebar risers. The embodiments disclosed below seek to remedy some of these issues.

### SUMMARY OF THE DISCLOSURE

In one embodiment, a vehicle comprises a plurality of ground engaging members and a steering system operably coupled to at least one of the plurality of ground engaging members and the steering system is configured to steer the at least one ground engaging member. The steering system further comprises a plurality of generally vertical tubes, a steering arm and a support structure. The support structure comprises a first portion extending between the generally vertical tubes and a second portion, and a display device is configured to be supported by the second portion.

In another embodiment, a steering assembly for a vehicle comprises a plurality of vertically upstanding members and a handlebar assembly coupled to the plurality of vertically upstanding members. The steering assembly further comprises a housing coupled to the plurality of vertically upstanding members and the housing is further configured to receive a display of the vehicle.

In yet another embodiment, a method of assembling a steering assembly for a vehicle comprises providing a plurality of vertical tubes configured to steer a ground engaging member. The method of assembling a steering assembly further comprising providing a first support structure configured with a receiving portion configured to receive a display and coupling the first support structure to the plurality of vertical tubes.

### BRIEF DESCRIPTION OF THE DRAWINGS

FIG. 1 is a front left perspective of a vehicle of the present disclosure;

FIG. 2 is a front left perspective view of a steering input of the vehicle of FIG. 1 coupled to a gauge mount of the present disclosure;

FIG. 3 is a rear left perspective view of the steering input and gauge mount of FIG. 2;

FIG. 4 is an exploded view of the steering input and gauge mount of FIG. 2;

FIG. 5 is a cross-sectional view of the steering input and gauge mount of FIG. 2, taken along line 5-5 of FIG. 2; and

FIG. 6 is a top view of a portion of the steering input and the gauge mount of FIG. 2.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

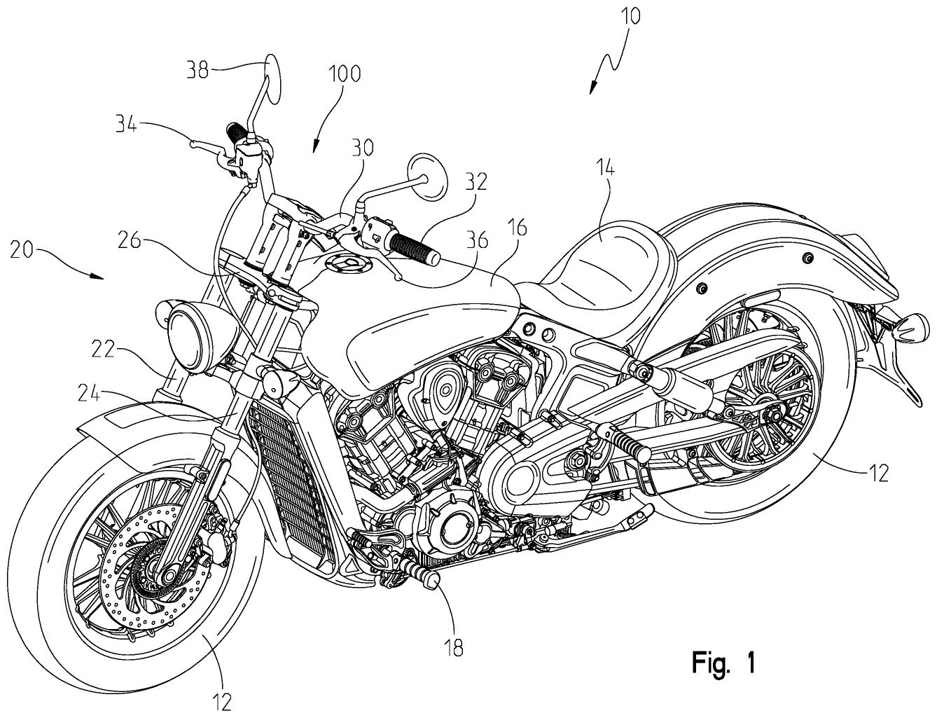

As shown in FIG. 1, a vehicle 10 is shown. Illustratively, vehicle 10 is a motorcycle. Vehicle 10 is supported by a plurality of ground engaging members 12. In an exemplary embodiment, there are two ground engaging members 12, which are shown as wheels. It is understood that tracks, skis, or a variety of other ground engaging members might be used. Vehicle 10 could be a variety of vehicles including, but not limited to, tricycles, snowmobiles, all-terrain vehicles, jet-skis or any other vehicle that utilizes a steering system. In the present embodiment, vehicle 10 further comprises a seat 14 configured to support an operator and, in some scenarios, a passenger (not shown.) Vehicle 10 further comprises a fuel tank 16 (illustratively located in front of seat 14) and a pair of footholds 18 configured to receive the feet of an operator.

Still referring to FIG. 1, vehicle 10 comprises a steering assembly 20 operably coupled to ground engaging members 12 for steering vehicle 10. In the present embodiment, steering assembly 20 comprises a first vertical tube 22 and a second vertical tube 24. First vertical tube 22 and second vertical tube 24 are illustratively configured as down tubes when vehicle 10 is configured as a motorcycle and, as such, are operably coupled together by a triple clamp 26. At the upper extent of triple clamp 26, a handlebar riser assembly 100 is included as part of steering assembly 20. Steering assembly 20 further includes a steering input, illustratively handlebars 30, and handlebar riser assembly 100 illustratively supports handlebar 30 which may be configured to comprise a pair of handgrips 32, a brake lever 34, a clutch lever 36, a plurality of mirrors 38, and various other components. Handlebar 30 is configured at the outer lateral extents to act as steering arms, being steerable by an operator (not shown). In other embodiments, the steering input of steering assembly 20 may be a steering wheel or any other movable input configured to steer ground engaging members 12.

While steering assembly 20 is shown with two vertical tubes, first vertical tube 22 and second vertical tube 24, it should be understood that a variety of configurations may be known that include more than two vertical tubes, including three tubes, four tubes, or more. Further, a steering assembly with no vertical tubes may still be used, wherein a handlebar riser assembly 100 may still be utilized.

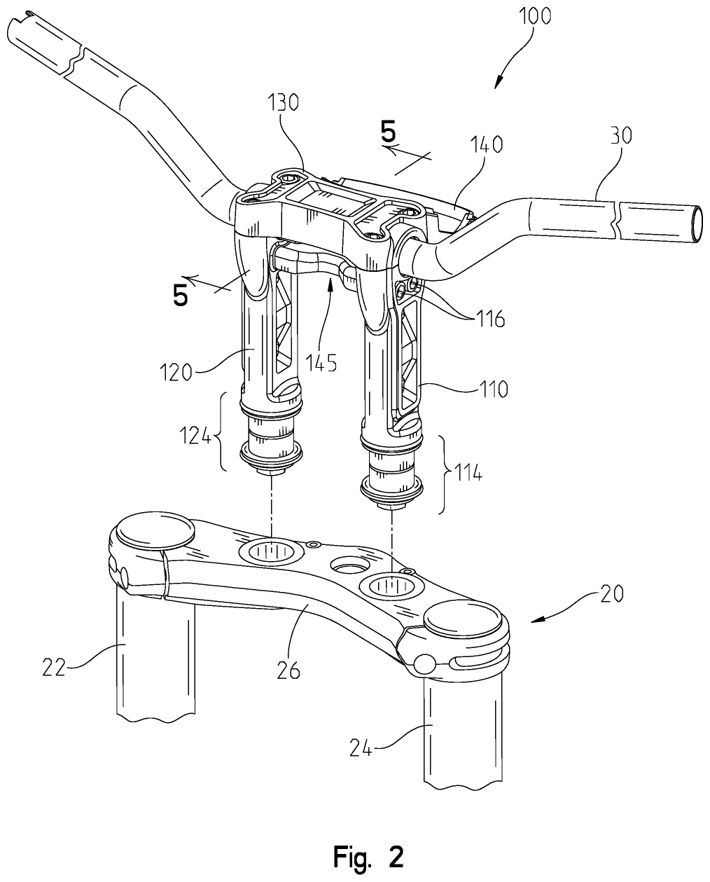

Turning now to FIG. 2, handlebar riser assembly 100 will be described in greater detail. Handlebar riser assembly 100 comprises a first riser 110 and a second riser 120 operably coupled to steering assembly 20 through a first coupling assembly 114 and a second coupling assembly 124, respectively. In the present embodiment, first coupling assembly 114 and second coupling assembly 124 are positioned at the lower extent of first riser 110 and second riser 120, respectively, and couple first riser 110 and second riser 120 to the upper extent of triple clamp 26 (FIG. 1). First coupling assembly 114 and second coupling assembly 124 may comprise a variety of components including at least a fastener, a washer, an isolator, and other components designed to couple first riser 110 and second riser 120 to steering assembly 20. By including the isolator(s), first coupling assembly 114 and second coupling assembly 124 may be isolating in nature to reduce the forces felt in the handlebar 30 from the remaining components of steering assembly 20. As seen in FIG. 2, first riser 110 and second riser 120 may have cutouts designed for weight reduction and/or aesthetic appeal.

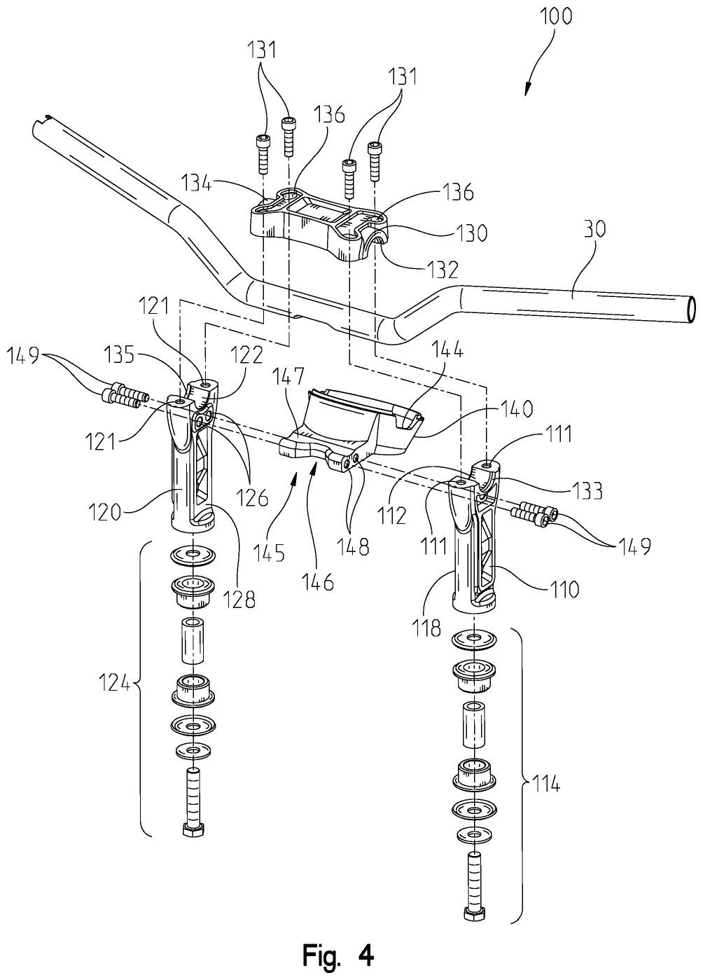

Handlebar riser assembly 100 further comprises a top cap 130 configured to interface with both first riser 110 and second riser 120, thereby connecting first riser 110 and second riser 120 at their upper extent. In this way, top cap 130 is a support member extending between first riser 110 and second riser 120. As shown in FIG. 4, first riser 110 comprises a first receiving portion 112 configured to interface with second receiving portion 132 on top cap 130 to create a first opening 133. Similarly, second riser 120 comprises a third receiving portion 122 configured to interface with fourth receiving portion 134 on top cap 130 to create a second opening 135. Handlebar 30 is configured as a single bar and extends through the length of top cap 130, through first opening 133 and second opening 135, and laterally outward towards both lateral extents of vehicle 10. In this way, handlebar 30 is configured to receive the hands of the operator (not shown) at an optimal position on either side of handlebar riser assembly 100.

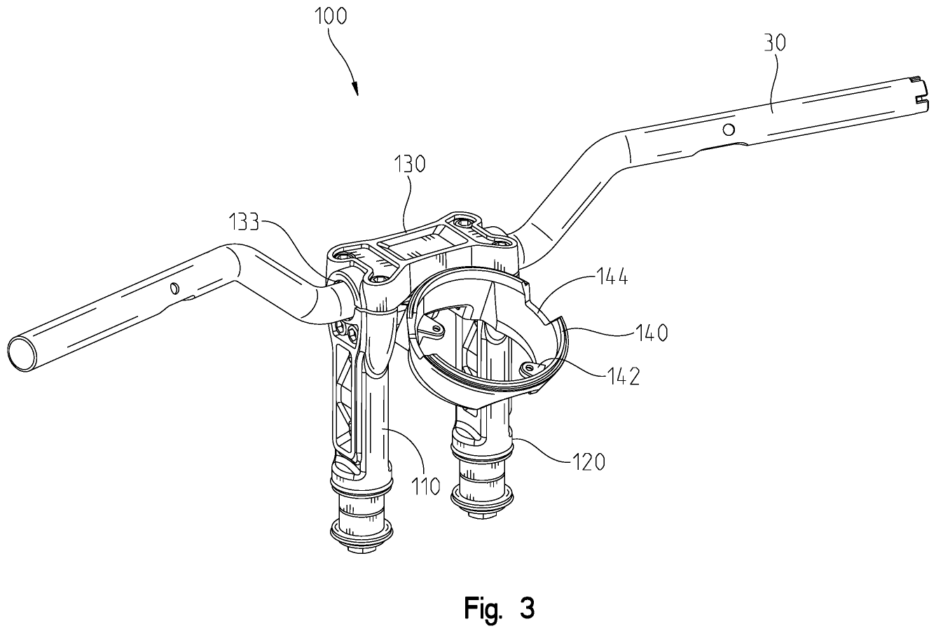

As is best seen in FIG. 3, handlebar riser assembly 100 is configured with a display housing or a gauge mount 140. Display housing 140 has a cavity configured to receive a display or gauge (not shown) and is further configured to have the display screen be approximately flush with the upper extent of display housing 140, or in a further embodiment, display screen may stick out above the upper extent of display housing 140. Display housing further comprises a support structure 145 located behind the display housing 140. The display may have physical or digital outputs (e.g., dials or digital alphanumeric references) to provide information to the operator. Additionally, or alternatively, the display may include mechanical or electrical inputs to allow the operator to make a selection about various aspects of vehicle 10. In one embodiment, the display may be a touchscreen display.

Display housing 140 is configured with a variety of features that allow for easier mounting of a display (not shown). Illustratively, display housing 140 comprises a plurality of mounting tabs 142, in an exemplary embodiment, display housing 140 is configured with two mounting tabs 142. Mounting tabs 142 are used to couple display to display housing 140. Further, display housing 140 comprises a plurality of clocking features 144 which are used to locate the display in the correct orientation. The display comprises a plurality of complementary clocking features that fit into clocking features 144 of display housing 140. Display housing 140 may be made out of a variety of materials including, but not limited to, machined aluminum, die-cast aluminum, plastic, composite, forged steel, or other common substances used in manufacturing processes.

The mounting configuration of display housing 140 onto handlebar riser assembly 100 will now be explained in greater detail. In FIG. 4, an exploded view of handlebar riser assembly 100 is shown, displaying first coupling assembly 114 and second coupling assembly 124 engaging first riser 110 and second riser 120, respectively. Further, the upper extent of first riser 110 is configured with a pair of first riser apertures 111, and the upper extent of second riser 120 is configured with a pair of second riser apertures 121. As is further viewable, top cap 130 is operably connected to first riser 110 and second riser 120 through the use of fasteners 131. In this way, a plurality of top cap apertures 136 align with first riser apertures 111 to receive fasteners 131 such that fasteners 131 extend through top cap 130 and first riser 110 for coupling therebetween. Similarly, a plurality of top cap apertures 136 cooperate with second riser apertures 121 to receive fasteners 131 such that fasteners 131 extend through top cap 130 and second riser 120 for coupling therebetween. In this way, top cap 130 is coupled to first riser 110 and second riser 120, and, as such, top cap 130 is configured as a support structure between first riser 110 and second riser 120.

As best seen in FIG. 2 and FIG. 4, first riser 110 is configured with a plurality of first horizontal apertures 116 (illustratively, two apertures 116), and second riser 120 is configured with a plurality of second horizontal apertures 126 (illustratively, two apertures 126). In a corresponding fashion, display housing 140 is configured with a plurality of support structure apertures 148 located on support structure 145. In an exemplary embodiment, both lateral extents of support structure 145 contain a pair of support structure apertures 148 that are configured to align with first horizontal apertures 116 and second horizontal apertures 126. Further, fasteners 149 are inserted through first horizontal apertures 116 and received by support structure apertures 148 on one lateral side of support structure 145, and fasteners 149 are inserted through second horizontal apertures 126 and received by a separate set of support structure apertures 148. In an exemplary embodiment, a pair of fasteners 149 are used on each lateral extent of support structure 145. In an exemplary embodiment, support structure apertures 148 are threaded to receive threaded fasteners 149.

The mounting structure of display housing 140 is unique for a number of reasons. There are a plurality of support structure apertures 148, and they are spaced to offset the moment force experienced by external pressures experienced by display housing 140. Further, support structure 145 extends the entire lateral width between an inner extent 118 (e.g., inner surface) of first riser 110 and an inner extent 128 (e.g., inner surface) of second riser 120. In this way, support structure 145 acts as a structural support member for handlebar riser assembly 100. The moment forces experienced within handlebar riser assembly 100 are reduced by the addition of the support structure 145 of display housing 140 between first riser 110 and second riser 120. Specifically, support structure 145 of display housing 140 is placed underneath top cap 130, and both top cap 130 and support structure 145 act as structural support for handlebar riser assembly 100 and they both carry axial forces experienced within first riser 110 and second riser 120. Further, support structure 145 is located underneath handlebar 30 which is located underneath top cap 130. It is understood that display housing 140, and thus support structure 145, may be moved further vertically downwards along first riser 110 and second riser 120. By moving display housing 140 further vertically downwards in the direction of coupling assemblies 114, 124 of first riser 110 and second riser 120, respectively, greater moment forces acting on first riser 110 and second riser 120 may be countered; however, display housing 140 is then located further from the operator.

It is understood that a handlebar riser assembly 100 with a greater height may translate greater moment forces to the handlebar riser assembly 100 from handlebar 30. Support structure 145 placed between first riser 110 and second riser 120 allows for greater forces to be countered by handlebar riser assembly 100, and in this way, handlebar riser assembly 100 can also have a greater vertical height because greater forces can be accommodated.

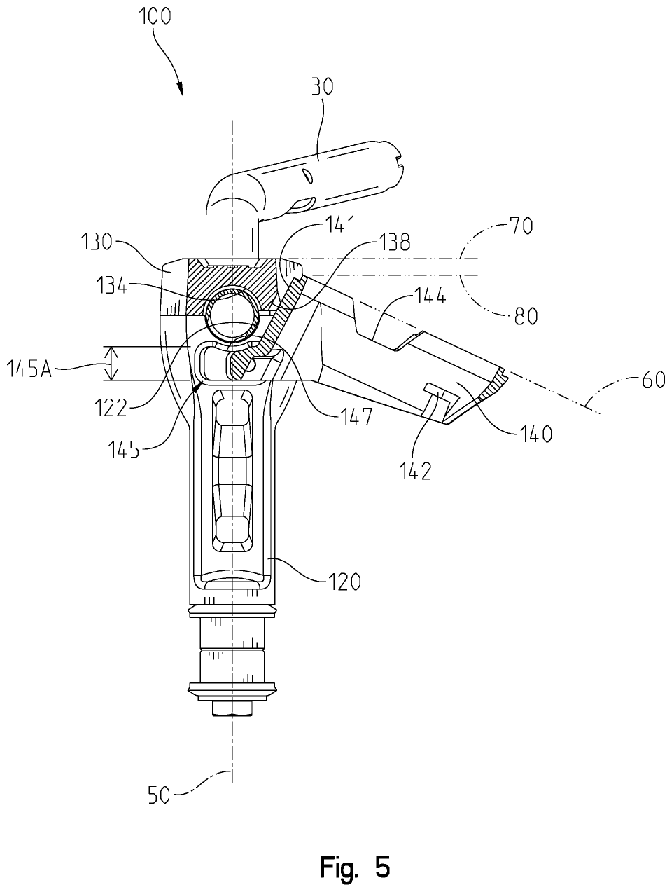

In another way, having display housing 140 mounted to handlebar riser assembly 100, display housing 140 is in a much more accessible location to operator than previous designs. More particularly, display housing 140 is closer to operator and maintains an appropriate angle relative to the operator for ideal viewing. Similarly, the present embodiment is a simpler packaging assembly and requires fewer parts than other designs. As seen in FIG. 5, a plane 60 extending along the upper surface or viewing surface of the display (not shown) is angled relative to the vertical centerlines 50 of first riser 110 and second riser 120. In an exemplary embodiment, the angle between axis 50 and plane 60 is less than 90 degrees, and more specifically, it is greater than 45 degrees. It is understood that the relative angle between vertical centerlines 50 and plane 60 could be any angle that might increase the viewability of the display within display housing 140.

As is best seen in FIG. 5, an upper extent 70 of top cap 130 is vertically above an upper extent 80 of display housing 140. Similarly, it should be appreciated that first horizontal apertures 116, second horizontal apertures 126, and fasteners 149 are located below handlebar 30.

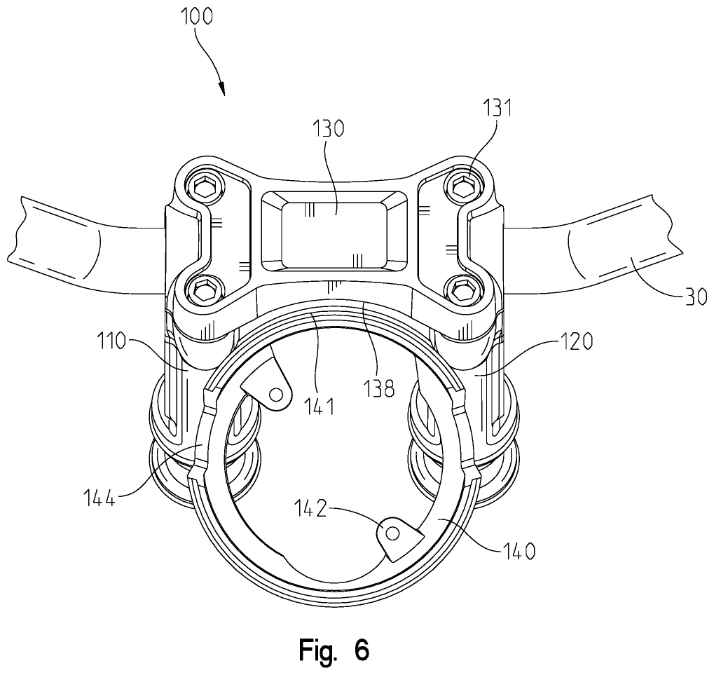

As can be further seen in FIG. 5, display housing 140 has a display housing surface 141 that is complementary to a top cap front surface 138. More particularly, as can be seen in FIG. 6, display housing surface 141 has a convex rounded shape that is complementary to the concave rounded shape of top cap front surface 138. The embodiment shown has a round display and thus the complementary features of display housing surface 141 and top cap front surface 138 are rounded or curved. In the present embodiment, top cap front surface 138 is a chamfer of top cap 130. It may be appreciated that a rectangular or square display might be used, and rectangular or square complementary features may be used instead. It also may be appreciated that any other reasonable shape might be used for the display housing 140.

As seen in FIG. 5, support structure 145 has a height 145A that is configured to receive support structure apertures 148. In another embodiment, height 145A of support structure 145 may be greater than pictured, thereby may extend downward to engage a greater portion/a longer length of both first riser 110 and second riser 120. In this way, a support portion 145 having a greater height 145A may assist in countering a larger moment force experienced by first riser 110 and second riser 120.

Turning back to FIG. 4, display housing 140 further comprises a cutout 146 in the rear extent of display housing 140. Cutout 146 may be used for routing electrical wires, brake lines, or any other routings that might extend between handlebar 30, handgrips 32, brake lever 34, clutch lever 36 or other components located along handlebar 30. In an exemplary embodiment, cutout 146 is a curved, generally U-shaped portion in the rear extent of display housing 140. Cutout 146 may further be configured as a thru-hole in display housing 140, or cutout 146 may further be configured with routing clips designed to hold or retain a plurality of wires. Cutout 146 may further cooperate with an opening within handlebar 30 that is designed to carry a plurality of wires, in this way a desirable aesthetic is achieved and fewer wires are visible to a viewer.

Further, display housing 140 comprises a profiled channel 147 across an upper surface of support structure 145. Profiled channel 147 is configured to complement the shape of handlebar 30. In this way, profiled channel 147 provides a greater aesthetic, and in another way, profiled channel 147 may provide for smaller packaging profiles because it allows display housing 140 to be able to be packaged closer to handlebar 30.

Additional details of vehicle 10 may be disclosed in U.S. Pat. No. 9,440,504, filed Mar. 14, 2014, and issued on Sep. 13, 2016 (Attorney Ref.: PLR-05-25858.05P-US); U.S. Pat. No. 9,421,860, filed Nov. 12, 2013 and issued on Aug. 23, 2016 (Attorney Ref.: PLR-12-25433.04P-US); and U.S. Pat. No. 9,394,859, filed Jul. 25, 2014 and issued on Jul. 19, 2016 (Attorney Ref.: PLR-12-26258.02P-US), the complete disclosures of which are expressly incorporated by reference herein. Additional details of a display configured to be supported by display housing 140 may be disclosed in U.S. patent application Ser. No. 15/161,720, filed May 23, 2016 (Attorney Ref.: PLR-12-27457.01P-US) and U.S. Pat. No. 10,315,719, filed Dec. 31, 2015, and issued on Jun. 11, 2019 (Attorney Ref.: PLR-12-27459.01P-US), the complete disclosures of which are expressly incorporated by reference herein.

### Examples

Example 1. A vehicle is provided. The vehicle comprising: a plurality of ground engaging members and a steering system operably coupled to at least one of the plurality of ground engaging members to steer the at least one ground engaging member. The steering system comprising a plurality of generally vertical tubes, a steering arm and a support structure. The support structure having a first portion extending between the generally vertical tubes and a second portion. A display device configured to be supported by the second portion.

Example 2. The vehicle of Example 1, wherein the first portion is vertically lower than the steering arm.

Example 3. The vehicle of Example 1, the steering system further comprising a top cap positioned atop the plurality of vertical tubes. The top cap has a curved interface to complement a curved portion of the support structure.

Example 4. The vehicle of Example 3, wherein the entirety of the support structure is vertically lower than an upper extent of the top cap.

Example 5. The vehicle of Example 1, wherein the second portion of the support structure is generally circular.

Example 6. The vehicle of Example 1, wherein the upper extent of the first portion of the support structure is vertically lower than the upper extent of the second portion of the support structure.

Example 7. The vehicle of Example 1, wherein the second portion of the support structure is angled relative to the generally vertical tubes.

Example 8. The vehicle of Example 1, wherein a first fastener removably couples a first generally vertical tube to the support structure and a second fastener removably couples a second generally vertical tube to the support structure.

Example 9. The vehicle of Example 8, wherein the first fastener and second fastener are vertically lower than the steering arm.

Example 10. A steering assembly for a vehicle is provided. The steering assembly comprising: a plurality of vertically upstanding members; a handlebar assembly coupled to the plurality of vertically upstanding members; and a housing coupled to the plurality of vertically upstanding members. The housing being configured to receive a display of the vehicle.

Example 11. The steering assembly of vehicle 10, wherein the housing is coupled to the plurality of vertically upstanding members at a position lower than the handlebar assembly.

Example 12. The steering assembly of vehicle 10, wherein the housing comprises a U-shaped portion configured to partially retain at least one wire of the vehicle.

Example 13. The steering assembly of vehicle 10, wherein the display is angled relative to the vertically upstanding members.

Example 14. A method of assembling a steering assembly for a vehicle is provided. The method comprising: providing a plurality of vertical tubes configured to steer a ground engaging member; providing a first support structure configured with a receiving portion configured to receive a display; and coupling the first support structure to the plurality of vertical tubes.

Example 15. The method of assembling a steering assembly of Example 14, wherein coupling the first support structure includes angling the receiving portion relative to the plurality of vertical tubes.

Example 16. The method of assembling a steering assembly of Example 14, further comprising coupling a second support structure to the plurality of vertical tubes.

Example 17. The method of assembling a steering assembly of Example 16, wherein coupling the second support structure includes positioning an upper extent of the second support structure vertically higher than an upper extent of the first support structure.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A vehicle, comprising:
a plurality of ground engaging members;
a steering system operably coupled to at least one of the plurality of ground engaging members to steer the at least one ground engaging member;
the steering system comprising a plurality of generally vertical tubes, a steering arm and a support structure;
the support structure having a first portion extending between the generally vertical tubes and a second portion; and
a display device configured to be supported by the second portion.

2. The vehicle of claim 1, wherein the first portion is vertically lower than the steering arm.

3. The vehicle of claim 1, the steering system further comprising a top cap positioned atop the plurality of vertical tubes; and
the top cap has a curved interface to complement a curved portion of the support structure.

4. The vehicle of claim 3, wherein the entirety of the support structure is vertically lower than an upper extent of the top cap.

5. The vehicle of claim 1, wherein the second portion of the support structure is generally circular.

6. The vehicle of claim 1, wherein the upper extent of the first portion of the support structure is vertically lower than the upper extent of the second portion of the support structure.

7. The vehicle of claim 1, wherein the second portion of the support structure is angled relative to the generally vertical tubes.

8. The vehicle of claim 1, wherein a first fastener removably couples a first generally vertical tube to the support structure and a second fastener removably couples a second generally vertical tube to the support structure.

9. The vehicle of claim 8, wherein the first fastener and second fastener are vertically lower than the steering arm.

10. A steering assembly for a vehicle, comprising:
a plurality of vertically upstanding members;
a handlebar assembly coupled to the plurality of vertically upstanding members; and
a housing coupled to the plurality of vertically upstanding members, the housing being configured to receive a display of the vehicle.

11. The steering assembly of vehicle 10, wherein the housing is coupled to the plurality of vertically upstanding members at a position lower than the handlebar assembly.

12. The steering assembly of vehicle 10, wherein the housing comprises a U-shaped portion configured to partially retain at least one wire of the vehicle.

13. The steering assembly of vehicle 10, wherein the display is angled relative to the vertically upstanding members.

14. A method of assembling a steering assembly for a vehicle, comprising:
providing a plurality of vertical tubes configured to steer a ground engaging member;
providing a first support structure configured with a receiving portion configured to receive a display; and
coupling the first support structure to the plurality of vertical tubes.

15. The method of assembling a steering assembly of claim 14, wherein coupling the first support structure includes angling the receiving portion relative to the plurality of vertical tubes.

16. The method of assembling a steering assembly of claim 14, further comprising coupling a second support structure to the plurality of vertical tubes.

17. The method of assembling a steering assembly of claim 16, wherein coupling the second support structure includes positioning an upper extent of the second support structure vertically higher than an upper extent of the first support structure.
